(19) United States
(12) Patent Application Publication
(10) Pub. No.: US 2026/0101129 A1
(43) Pub. Date: Apr. 9, 2026

(54) MULTI-VERSION COMMUNICATION SYSTEM

(71) Applicant: G.S. CONSULTING & RESEARCH CORRENET LTD, Nes Ziona (IL)

(72) Inventor: Oran Moshe, Mashen (IL)

(21) Appl. No.: 18/907,740

(22) Filed: Oct. 7, 2024

(51) Int. Cl. H04Q 3/00; G06F 8/71; H04Q 3/62

(52) U.S. Cl. CPC H04Q 3/0095; G06F 8/71; H04Q 3/62

(57) ABSTRACT

Method, system and computer program product, the product comprising a non-transitory computer readable medium retaining instructions, which when read by a processor, cause the processor to: execute business logic applicable to first and second versions of a telephone exchange system, wherein communication with the first/second version is performed using an object of a first/second class compatible with the first/second version and not with the second/first version, and wherein the business logic is implemented using a universal object of a universal class comprising all fields and methods of the first and second classes; in response to determining to communicate with a first/second system implementing the first/second version: transform the universal object into a first/second object; and transmit the first/second object to the first/second system; wherein the processor is part of a computerized system that comprises a plurality of version-heterogenous telephone exchange systems, including the first and the second telephone exchange systems.

### TECHNICAL FIELD

The present disclosure relates to communication systems in general, and to a method and apparatus for implementing and operating a communication network with multiple versions of a telephone exchange system, in particular.

### BACKGROUND

A communication system, including a telephony system is one of the most significant backbones of many organizations, such as commercial companies, government offices, educational institutions, or others.

A telephony system of an organization typically comprises one or more telephony exchange systems, such as a Private Branch Exchange (PBX) implemented for example as a CUCM™ (Cisco™ Unified Communication Manager), wherein larger or distributed organizations may employ a plurality of co-located or distributed PBXs. An organization may adapt the telephony system in accordance with the changing needs of the organization, for example adding PBXs as the organization grows, whether due to the addition of a site, growing number of employees, or the like.

The PBXs may be connected to a management system, responsible for deploying business logic of the organization, including for example configuring the PBXs, initiating a PBX, backing up the information of the PBXs, or the like.

### BRIEF SUMMARY

One exemplary embodiment of the disclosed subject matter is a computer program product comprising a non-transitory computer readable medium retaining program instructions, which instructions when read by a processor, cause the processor to perform: executing a business logic that is applicable to a first version of a telephone exchange system provided by a provider and to a second version of the telephone exchange system provided by the provider, wherein communication with the first version of the telephone exchange system is performed using an object of a first class, the first class is compatible with the first version and is incompatible with the second version, wherein communication with the second version of the telephone exchange system is performed using an object of a second class, the second class is compatible with the second version and is incompatible with the first version, and wherein the business logic is implemented using a universal object of a universal class, the universal class comprises all fields and methods of the first class and of the second class; in response to a determination to communicate with a first telephone exchange system, which implements the first version of the telephone exchange system: transforming the universal object into a first object of the first class; and transmitting the first object to the first telephone exchange system; and in response to a determination to communicate with a second telephone exchange system, which implements the second version of the telephone exchange system: transforming the universal object into a second object of the second class; and transmitting the second object to the second telephone exchange system, wherein the processor is part of a computerized system that comprises a plurality of version-heterogenous telephone exchange systems, including at least the first telephone exchange system and the second telephone exchange system. Within the computer program product, code of the universal class is optionally implemented upon first code segment implementing the first class and a second code segment implementing the second class. Within the computer program product, the first code segment or the second code segment is optionally a high level code generated upon a Web Service Description Language (WSDL) description of an interface accessed by a corresponding communication system. Within the computer program product, the first code segment or the second code segment is optionally Java code. Within the computer program product, said transforming optionally comprises casting the object into the second object. Within the computer program product, second object is optionally transmitted using Simple Object Access Protocol (SOAP). Within the computer program product, the universal class is optionally implemented at least partially automatically based on the first class and of the second class. Within the computer program product, prior to said executing, the processor may further perform: receiving an input object from the first telephone exchange system; and transforming the input object into the universal object.

Another exemplary embodiment of the disclosed subject matter is a computer-implemented method comprising: executing a business logic that is applicable to a first version of a telephone exchange system provided by a provider and to a second version of the telephone exchange system provided by the provider, wherein communication with the first version of the telephone exchange system is performed using an object of a first class, the first class is compatible with the first version and is incompatible with the second version, wherein communication with the second version of the telephone exchange system is performed using an object of a second class, the second class is compatible with the second version and is incompatible with the first version, and wherein the business logic is implemented using a universal object of a universal class, the universal class comprises all fields and methods of the first class and of the second class; in response to a determination to communicate with a first telephone exchange system, which implements the first version of the telephone exchange system: transforming the universal object into a first object of the first class; and transmitting the first object to the first telephone exchange system; and in response to a determination to communicate with a second telephone exchange system, which implements the second version of the telephone exchange system: transforming the universal object into a second object of the second class; and transmitting the second object to the second telephone exchange system, wherein the processor is part of a computerized system that comprises a plurality of version-heterogenous telephone exchange systems, including at least the first telephone exchange system and the second telephone exchange system. Within the method, code of the universal class is optionally implemented upon a first code segment implementing the first class and a second code segment implementing the second class. Within the method, the first code segment or the second code segment is optionally a high-level code generated upon a Web Service Description Language (WSDL) description of an interface accessed by a corresponding communication system. Within the method, the first code segment or the second code segment is optionally Java code. Within the method, said transforming optionally comprises casting the object into the second object. Within the method, the second object is optionally transmitted using Simple Object Access Protocol (SOAP). Within the method, the universal class is optionally implemented at least partially automatically based on the first class and of the second class. Within the method, prior to said executing, the processor may further perform: receiving an input object from the first telephone exchange system; and transforming the input object into the universal object.

Yet another exemplary embodiment of the disclosed subject matter is a system having a processor, the processor being configured to perform the steps of: executing a business logic that is applicable to a first version of a telephone exchange system provided by a provider and to a second version of the telephone exchange system provided by the provider, wherein communication with the first version of the telephone exchange system is performed using an object of a first class, the first class is compatible with the first version and is incompatible with the second version, wherein communication with the second version of the telephone exchange system is performed using an object of a second class, the second class is compatible with the second version and is incompatible with the first version, and wherein the business logic is implemented using a universal object of a universal class, the universal class comprises all fields and methods of the first class and of the second class; in response to a determination to communicate with a first telephone exchange system, which implements the first version of the telephone exchange system: transforming the universal object into a first object of the first class; and transmitting the first object to the first telephone exchange system; and in response to a determination to communicate with a second telephone exchange system, which implements the second version of the telephone exchange system: transforming the universal object into a second object of the second class; and transmitting the second object to the second telephone exchange system, wherein the processor is part of a computerized system that comprises a plurality of version-heterogenous telephone exchange systems, including at least the first telephone exchange system and the second telephone exchange system. Within the system, code of the universal class is optionally implemented upon first code segment implementing the first class and a second code segment implementing the second class, wherein the first code segment or the second code segment is optionally a high level code generated upon a Web Service Description Language (WSDL) description of an interface accessed by a corresponding communication system, and wherein the first code segment or the second code segment is optionally Java code. Within the system the second object is optionally transmitted using Simple Object Access Protocol (SOAP). Within the system, prior to said executing, the processor may further perform: receiving an input object from the first telephone exchange system; and transforming the input object into the universal object.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a currently available communication network;

FIG. 2 is a schematic illustration of a communication network, in accordance with some exemplary embodiments of the disclosure;

FIG. 3 is a schematic diagram of the code or description manipulated for generating a unified class, in accordance with some exemplary embodiments of the disclosure;

FIG. 4 is an exemplary diagram of the operation of a network, in accordance with some exemplary embodiments of the disclosure; and

FIG. 5 is a schematic block diagram of a computing platform for managing a plurality of version-heterogenous telephone exchange systems, in accordance with some exemplary embodiments of the disclosure.

### DETAILED DESCRIPTION

In the disclosure below, the terms PBX, telephone exchange system, communication system and telephone communication system are used interchangeably.

A typical communication network in an organization comprises one or more telephone exchange systems, such as but not limited to a private branch exchange (PBX) systems. In addition, the network may comprise a management system, adapted to communicate with the various telephone exchange systems for implementing the business logic of the organization, such as setting or changing a configuration, starting or stopping a PBX, backing up information, responding to requests issued by the telephone communication systems, or the like.

Organizations may adapt their resources, including their communication network, to their changing needs. Thus, an organization that is growing in the number or distribution of its sites, in the number of employees, or the like, may add further PBXs to its network. Ideally, such change does not affect the existing PBXs. Therefore, since the PBXs provided by a same provider may keep evolving and new versions may be released, over time the communication network comprises various versions of a telephone exchange system, which should all be managed by the management system.

Traditionally, the management system handles and communicates with each PBX version available in the organization, using software objects and units of the management system which are compatible with the version.

Thus, one technical problem dealt with by the disclosed subject matter is that objects and components used by the management system for communication with one version of the PBX are incompatible with other version, thus the management system cannot use them to communicate with other PBXs. Therefore, the management system needs to communicate using separate objects and components with each of the PBXs types available within the communication network, including PBXs provided by the same provider and being advanced versions of one another.

The differences between the software for old and new versions may be minimal, and may consist mainly of added fields and capabilities. For example, less than 10%, less than 5% or less than 1% of the code is different between different revisions of the same PBX. However, in current solutions, the business logic that is applicable to all the PBXs still needs to be duplicated for each version of the PBX versions available in the organization, such that the management system can communicate and provide the functionality to each corresponding PBX. Naturally, duplicating software means redundancy and makes it hard to maintain the code. A change in any of the versions requires reviewing the code in all other versions, copying, making the required adaptations, compiling and deploying of the updated code. The redundancy is known to be labor-intensive, error-prone, and generally risky to the operational status of the communication network. Therefore, it is required to case and enhance the management of such communication networks which comprise multiple versions of telephone exchange systems.

Another currently available solution comprises replacement of the older PBXs with the newer version any time a PBX of a new version is deployed, which is of course highly costly and impractical.

One current solution provided by the disclosure comprises executing business logic that is applicable to all the PBX versions in the organizations, using a universal object of a universal class compatible with all PBX versions. While each of the various PBXs communicates with the management system using compatible objects having fields and methods relevant to its particular version, the universal class may comprise fields and methods which are the unification of all fields and methods of all specific classes, and can therefore be used for handling the business logic for all PBX versions.

Once the business logic has been executed on the universal object, the management system may transform the universal object to a specific object compatible with one of the PBX systems, and may transmit the object to the relevant PBX. The management system may repeat the transformation and transmission to all PBXs. The transformation may optionally use a casting mechanism available in the underlying programming language. However, any other transformation method may be deployed.

In some examples, the business logic needs to be executed in response to a request from a PBX of a specific version. In such case, the request may be transmitted using an object of a specific type compatible with the PBX. The object may then be transformed into a universal object of the universal type, followed by executing the business logic on the universal object, transforming it back to the object compatible with the PBX and transmitting the object.

In some non-limiting examples, the object transmitted as a request and/or response may be transmitted using a Simple Object Access Protocol (SOAP).

In some embodiments, the code implementing the specific classes may be generated upon a description associated with the corresponding PBX. For example, the description may be provided in a Web Service Description Language (WSDL) which describes the relevant requests and corresponding responses the PBX provides, e.g., its interface. The description may then be parsed, and code in high-level language, such as Java, may be generated based thereon. In a non-limiting example, the specific class code generation may be done by a Java API for XML Web Services (JAX-WS) fully compliant framework, such as Apache CXF™ which may be used as a plug-in to a development environment.

The code for the universal class may then be generated automatically, manually or in a hybrid manner upon the high-level code generated for each specific class. Generating the universal code in an automatic or semi-automatic manner may be efficient since the differences between various versions of the PBXs are typically slight, and consist of added methods and fields or members. Thus, a universal class may be generated by aggregating all fields or members and all methods of the specific classes.

If such automatic aggregation is not straight-forward, for example the same field has different types in different specific classes, the field may be assigned a type that is higher in the class hierarchy and is a base type for all the different types, such as “Object”. Additionally, multiple versions of functions receiving objects of these types as parameters may be provided, wherein it is the responsibility of the code implementing the business logic to make the call with the correct parameters. In further embodiments, a corresponding notice may be provided and a user may need to resolve the situation.

One technical effect of the disclosure is the provisioning of a solution for managing communication exchange systems of multiple versions or generations in the environment. Unlike the trivial currently available solution, the disclosure provides for eliminating duplicate code which needs to be repeated for each type of PBX in the organization, thereby providing for saving redundant labor and possible errors.

The addition of a communication exchange system of a new generation to the organization network may thus be almost seamless, require little effort and cost, and reduce the probability of errors.

The disclosure also makes irrelevant the option of upgrading all PBXs in the organization when a PBX of a new version is added to the organization network.

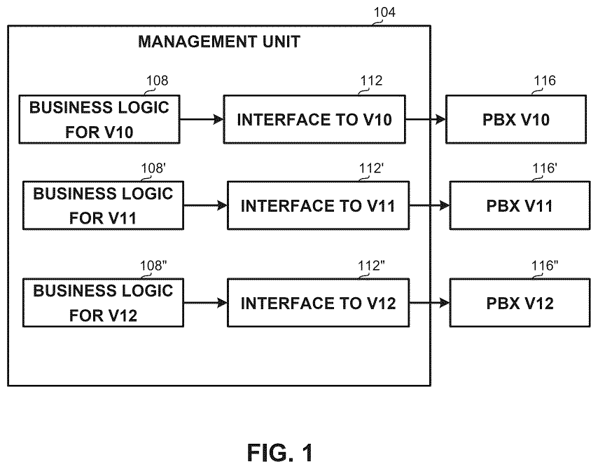

Referring now to FIG. 1, showing a schematic illustration of a currently available communication network.

The network comprises one or more PBXs, also referred to as telephony exchange systems or communication exchange systems. The PBXs may comprise PBXs of different versions, for example PBX V10 (116), PBX V11 (116′), and PBX V12 (116″) having versions 10, 11 and 12, respectively. The PBXs above may be provided by the same provider, and may be different versions, for example increasingly advanced versions or generations of PBXs of a same series.

It is appreciated that the network may comprise one or more PBXs of each version, and may serve multiple organizations (multi-tenancy). For example, one organization may have two PBXs of type V10 (116) and one PBX of type V11 (116′), and a second organization may have one PBX of type V10 (116) and two PBXs of type V12 (116″).

The network may also comprise Management Unit 104 for communicating with the PBXs for purposes such as performing actions such as setting or updating configurations, starting or stopping a PBX, backup, or the like.

Management Unit 104 may comprise a business logic component for each version of PBX available in the network. Thus, Management Unit 104 may comprise Business Logic Component for V10 (108), Business Logic Component for V11 (108′) and Business Logic Component for V12 (108″). Each Business Logic Component 108, 108′ and 108″ may operate on one or more objects compatible with the corresponding PBX version, and uses a corresponding interface to send the objects or messages to the relevant PBX(s). Thus, business logic component for V10 (108) sends the object to Interface to V10 (112), Business Logic Component for V11 (108′) sends the object to Interface to V11 (112′), and Business Logic Component for V12 (108″) sends the object to Interface to V12 (112″). Each interface then transmits the object to the relevant PBX, such that Interface to V10 (112) transmits the object to one or more PBXV10 (116), Interface to V11 (112′) transmits the object to one or more PBX V11 (116′), and Interface to V12 (112″) transmits the object to one or more PBX V12 (116″).

It is appreciated that typically significant parts of the code in Business Logic Component for V10 (108), Business Logic Component for V11 (108′) and Business Logic Component for V12 (108″) is duplicated, and when a PBX of a new version becomes available in the network, the code is duplicated once more. Moreover, when a bug fix or another change is required, it needs to be repeated in all components, which is of course labor intensive and error prone.

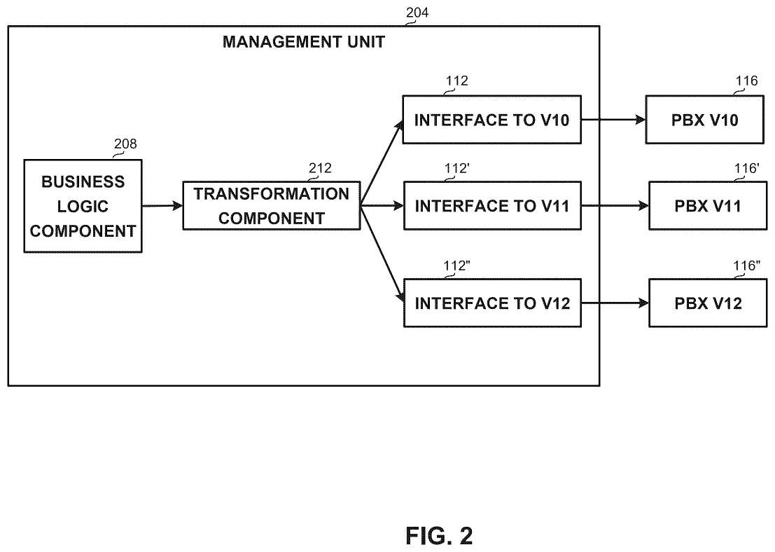

Referring now to FIG. 2, showing a schematic illustration of a communication network, in accordance with some exemplary embodiments of the disclosure.

The network comprises as before one or more of PBX V10 (116), PBX V11 (116′), and PBX V12 (116″) which are different versions of a same PBX.

The network comprises a Management Unit 204 in communication with all PBXs of all versions.

Management Unit 204 comprises a Business Logic Component 208, which operates on an object that is based on and compatible with all objects specific to one or more PBX versions, as detailed below.

Thus, Business Logic Component 208 is a unified component (may be implemented as multiple components) that is executed in the same manner, regardless of the PBX or PBXs it needs to communicate with and provide services to.

Once Business Logic Component 208 has performed its tasks over the unified object of the unified class, the object may be transformed once or more by Transformation Component 212 according to the PBXs it is supposed to apply the business logic to. Thus, the unified object may be transformed by Transformation Component 212 to a specific object compatible with PBX V10 (116). The specific object may be transmitted through Interface to V10 (112) to the one or more PBX V10 (116) available in the network. The specific object may be transmitted through Interface to V10 (112) to the one or more PBX V10 (116) available in the network. Additionally or alternatively, the unified object may be transformed by Transformation Component 212 to another specific object compatible with PBX V11 (116′) or PBX V12 (116″) and transmitted through the corresponding Interface to V11 (112′) or Interface to V12 (112″) to the one or more PBX V11 (116′) or PBX V12 (116″) available in the network.

Thus, a single business logic component is operative for providing the business logic to all components, thereby eliminating the need for redundant duplicate code.

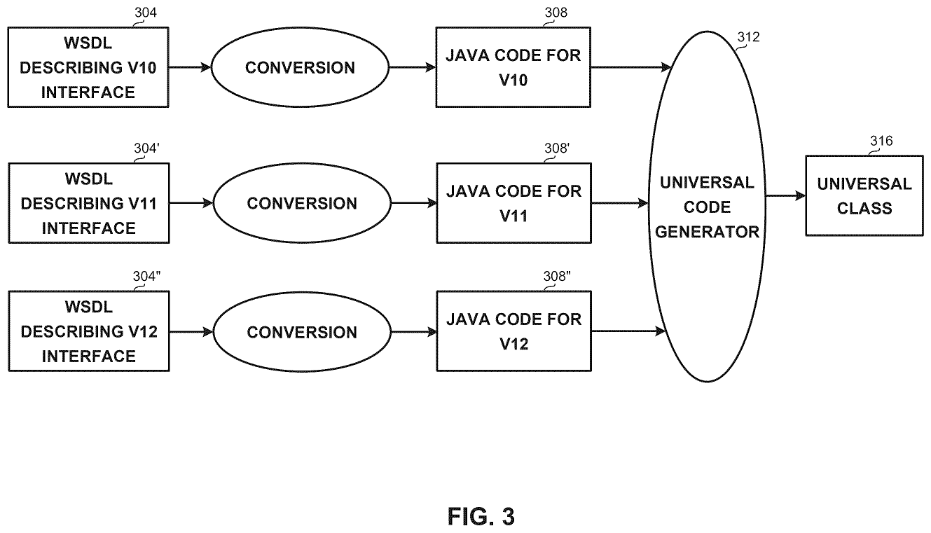

Referring now to FIG. 3, showing a schematic diagram of the code or description manipulated for generating the unified class, which Business Logic Component 208 operates upon an object of the unified class, in accordance with some exemplary embodiments of the disclosure.

Each version of the PBX is associated with a description of its interface. The description may be generated automatically, manually, or in a hybrid manner. In some examples, the description may be provided in Web Service Description Language (WSDL), wherein WSDL is an Extensible Markup Language (XML) notation for describing a web service. A WSDL definition indicates how to compose a web service request and describes the interface that is provided by the web service provider. Thus, the description provides the definition of the various requests that can be made to the web service with the required parameters, and the corresponding responses.

Thus, a WSDL 304 may define ports of the PBX of version V10, which can compile into a Java interface, and similarly for WSDL 304′ for a PBX of version V11, and WSDL 304″ for a PBX of version V12.

Each WSDL may be processed by a convertor such as Apache CXF, to convert the WSDL into an object description in high level language, such as Java. Thus, WSDL 304 is transformed into Java code for PBX V10 (308), WSDL 304′ is transformed into Java code for PBX V11 (308′), and WSDL 304″ is transformed into Java code for PBX V12 (308″). The code conversion may be performed using a Maven plugin, or in any other framework.

Java codes 308, 308′ and 308″ for the specific classes may then be provided to a Universal Code Generator 312, to generate a universal class 316.

Universal Code Generator 312 may aggregate all fields and methods from multiple specific classes into a universal class. As long as identically named fields are of the same type in the specific classes, and identically named methods are implemented in the same manner, aggregation may proceed by simply providing the fields and methods. If collisions such as type mismatch between fields having the same name or different method implementations are encountered, Universal Code Generator 312 may automatically provide all the relevant options for the functions and for setting values to the members. Universal Code Generator 312 may be implemented as a plug-in installed in a development environment, as a standalone program or application, as a web service, or the like.

For example, given the following code for system version 10:

```
public static class V10_PBX{
  public V10_PBX{ } ( )
    private String enableFax = “FALSE;”
    public String getEnableFax( ) { return enableFax; }
    public void setEnableFax(String enableFax) {
      this.enableFax = enableFax; }
  }
```

and the following code for system version 14:

```
public static class V14_PBX{
  public V14_PBX{ } ( )
    private boolean enableFax = FALSE;
    public boolean getEnableFax( ) { return enableFax; }
    public void setEnableFax(boolean enableFax) {
      this.enableFax = enableFax; }
  }
```

The following universal code may be generated:

```
public static class UniversalExample {
  public UniversalExample( ) { }
    private Object enableFax;
    public Object getEnableFax( ) { return enableFax; }
    public void setEnableFax(boolean enableFax) {
      this. enableFax = enableFax; }
    public void setEnableFax(String enableFax) {
      this.enableFax = enableFax; }
}
```

It is seen that the codes for the different versions of the system differ in the type of the enableFax variable. Therefore the universal code comprises a single getEnableFax method that returns a variable of type object which may then be cast by the user in the calling code, e.g., the code implementing the business logic.

The universal code further comprises the two versions for the setEnableFax method, each with the corresponding type for the input parameter. Thus, the relevant method will be invoked depending on the input parameter used by the calling code.

The following code is an exemplary user code that uses the universal code:

```
static void enableFaxFeature(Class clazz) throws JsonProcessingException
{
// Read input from the PBX.
String json = readFromPBX(class1);
// Perform some logic.
UniversalExample universalExample = gson.fromJson(json,
  UniversalExample.class);
  if (V10_PBX.class.equals(class1)) //meaning that the enableFax is a
  string
  universalExample.setEnableFax(“TRUE”);
  else if (V14_PBX.class.equals(class1)) //meaning that the enableFax
  is a boolean
  universalExample.setEnableFax(true);
  // Send the changes back to thePBX.
  json = gson.toJson(universalExample);
  Object pbx = new Gson( ).fromJson(json, class1);
  sendToPBX(pbx);
}
```

It is thus seen that the calling code, implementing the business logic needs to call the method with the relevant parameter type. It is appreciated that this code can be easily extended to support additional types of the variable enableFax.

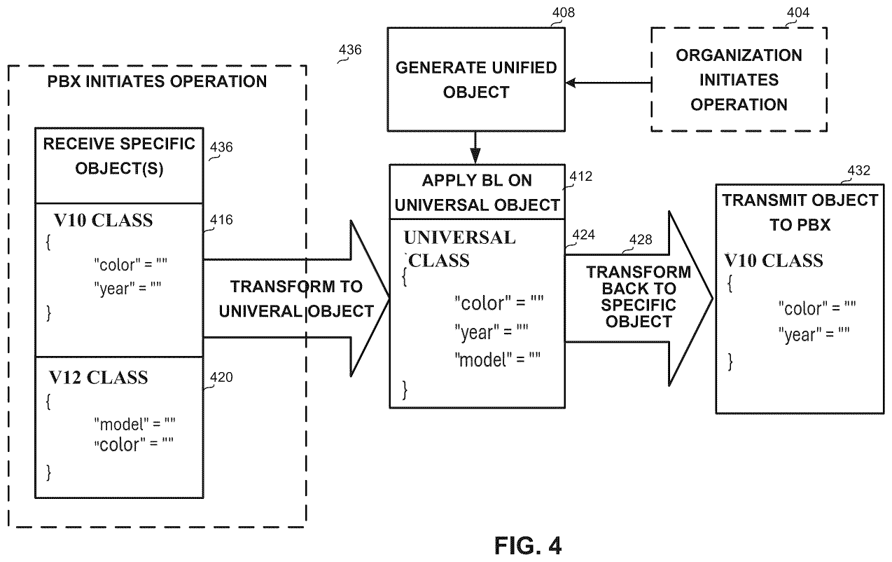

Referring now to FIG. 4, showing an exemplary diagram of the operation of a telephone network, in accordance with some exemplary embodiments of the disclosure.

The operation may be performed, for example, by network manager 204.

The operation may be initiated by the organization, for example by a personnel member such as an IT person, automatically as a scheduled operation, according to a need that arises, or the like. The operation may be for example a change in the configuration, activating a PBX, adding functionality, or the like, and may be applicable to one or more PBXs.

Additionally or alternatively, the operation may be initiated by one or more of the PBXs and may be applicable to that PBX.

In the first case, at step 404, the organization, or a human or computerized entity therein may initiate the operation.

At step 408, Network Manager 204 may create a universal object which is an instance of universal class 316 generated as described in association with FIG. 3 above, and at step 412 Network Manager 204 may manipulate the universal object and apply the business logic to the universal object.

For example, the specific classes may include V10 Class (416) applicable to a PBX of version 10 and comprising the fields of “color” and “year”, and V12 Class (420) applicable to a PBX of version 12 comprising the fields of “model” and “color”. Universal class 424 therefore comprises the unification of the fields: “color”, “year” and “model”.

At step 428, a universal object which is an instance of the universal class, after being manipulated in accordance with the business logic, may be transformed once or more into specific objects, according to the PBXs it needs to communicate with. For example, if the operation is to be applied to a PBX of version 10, the unified object is transformed back to an object of V10 class 416 having the fields of “color” and “year”, by eliminating the “model” field.

At step 432, the transformed object may be transmitted to the one or more PBXs of the V10 version in the organization. The transmission may be performed under the Simple Object Access Protocol (SOAP).

If the operation is initiated by a specific PBX, such as a PBX of type V10, at step 436 Network Manager 204 may receive an object which is an instance of the specific class from the PBX, for example using SOAP.

At step 440, Network Manager 204 may transform the object to an object of the universal class.

Network Manager 204 may then proceed as above, to apply the business logic at step 412, transform the object back to a specific object compatible with the sending PBX at step 428, and transmit the specific object to the initiating PBX at step 432.

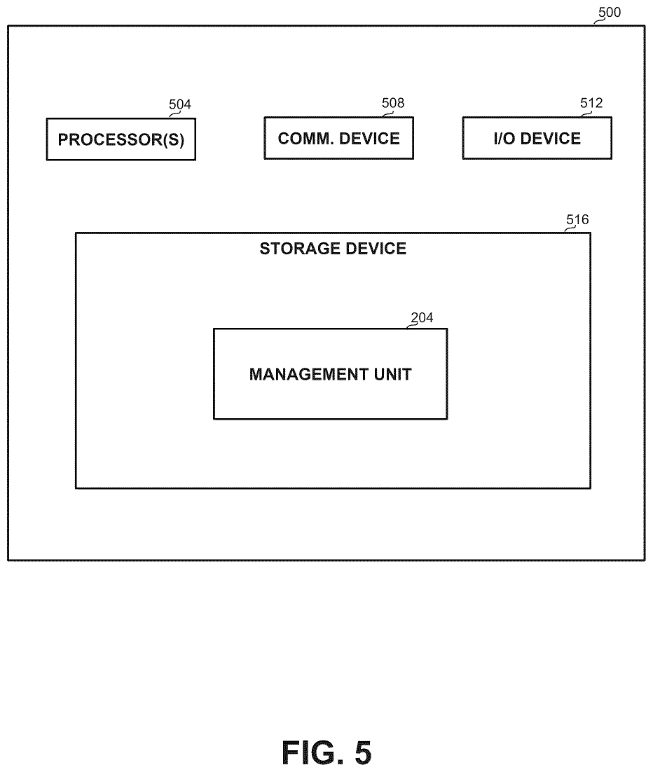

Referring now to FIG. 5, showing a schematic block diagram of a Computing Platform 500 for managing a plurality of version-heterogenous telephone exchange systems, in accordance with some exemplary embodiments of the disclosure.

It will be appreciated that Computing Platform 500 may be a dedicated computing platform or may serve other purposes as well, may be a server, may be located on-premise or remote, or the like.

Computing Platform 500 may be implemented as one or more computing platforms which may be operatively connected to each other. For example, one or more remote computing platforms, which may be implemented for example on a cloud computer. Other computing platforms may be a part of a computer network of the associated organization. In other embodiments, all the functionality may be provided by one or more computing platforms all being a part of the organization network.

The computing platform may be a part of a computerized system that comprises a plurality of version-heterogenous telephone exchange systems.

Computing platform 500 may comprise one or more Processors 504 located on the same computing platform or not, which may be one or more central processing units (CPU), graphics processing unit (GPU) microprocessors, electronic circuits, Integrated Circuits (IC) or the like. Processor 504 may be configured to provide the required functionality, for example by loading to memory and activating the software modules stored on Storage Device 516 detailed below.

Computing platform 500 may comprise Input/output (I/O) Device 508, such as a microphone, a display, a keyboard, a touch screen, a mouse or another pointing device, a speaker, or the like. I/O Device 508 may be utilized to receive input from and provide output to a user such as a system administrator, or the like.

Computing platform 500 may comprise a Communication Device 512 for communicating with other devices or other computing platforms, for example the telephone exchange systems. Communication Device 512 may be adapted to interface with any communication channel such as Local Area Network (LAN), Wide Area Network (WAN), cellular network or the like, and use any relevant communication protocol.

Computing platform 500 may comprise a Storage Device 516, such as a hard disk drive, a Flash disk, a Random Access Memory (RAM), a memory chip, or the like. In some exemplary embodiments, Storage Device 516 may retain program code operative to cause Processor 504 to perform acts associated with Network Manager 204 or steps of the method of FIG. 4 above. The program code may comprise one or more executable units, such as functions, libraries, standalone programs or the like, adapted to execute instructions as detailed below.

Alternatively or additionally, the provided instructions may be stored on non-transitory tangible computer-readable media, such as magnetic, optical, or electronic memory.

Storage Device 516 may comprise Network Manager 204 detailed above. It is appreciated that Interface to V10 (112), Interface to V11 (112′) and Interface to V12 (112″) may utilize communication device 508 to communicate with the respective telephone exchange systems using.

Thus, Processor 504 executes a business logic applicable to multiple versions of a telephone exchange system provided by a same provider, wherein communication with each version of the telephone exchange system is performed using an object of a class compatible with the corresponding version and incompatible with one or more other versions. The business logic is implemented using a universal object of a universal class which comprises all fields and methods of the specific classes. In response to determining a need to communicate with any of the telephone exchange system, the universal object is transformed into an object corresponding to the specific telephone exchange system, the object is transmitted to the telephone exchange system.

It is appreciated that the disclosure above is not limited to communication exchange systems, and can be equally applicable to any other product and domain where it is required to manage multiple versions of a same product, wherein the similarity degree between the version is relatively high, for example at least 80%, at least 90%, at least 95%, or at least 99% of the code in one of the versions is identical to code appearing in another version. Thus, the disclosure ban be applied to generating high-level code from a description, and unifying the code, for example generating one or more universal classes comprising all fields, members, and methods of multiple versions of a telephone exchange system, applying the business logic to objects of the universal class, and transforming the object back to the corresponding version.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A computer program product comprising a non-transitory computer readable medium retaining program instructions, which instructions when read by a processor, cause the processor to perform:
executing a business logic that is applicable to a first version of a telephone exchange system provided by a provider and to a second version of the telephone exchange system provided by the provider,
wherein communication with the first version of the telephone exchange system is performed using an object of a first class, the first class is compatible with the first version and is incompatible with the second version,
wherein communication with the second version of the telephone exchange system is performed using an object of a second class, the second class is compatible with the second version and is incompatible with the first version, and
wherein the business logic is implemented using a universal object of a universal class, the universal class comprises all fields and methods of the first class and of the second class;
in response to a determination to communicate with a first telephone exchange system, which implements the first version of the telephone exchange system:
transforming the universal object into a first object of the first class; and
transmitting the first object to the first telephone exchange system; and
in response to a determination to communicate with a second telephone exchange system, which implements the second version of the telephone exchange system:
transforming the universal object into a second object of the second class; and
transmitting the second object to the second telephone exchange system,
wherein the processor is part of a computerized system that comprises a plurality of version-heterogenous telephone exchange systems, including at least the first telephone exchange system and the second telephone exchange system.

2. The computer program product of claim 1, wherein code of the universal class is implemented upon a first code segment implementing the first class and a second code segment implementing the second class.

3. The computer program product of claim 2, wherein the first code segment or the second code segment is a high level code generated upon a Web Service Description Language (WSDL) description of an interface accessed by a corresponding communication system.

4. The computer program product of claim 2, wherein the first code segment or the second code segment is Java code.

5. The computer program product of claim 1, wherein said transforming comprises casting the object into the second object.

6. The computer program product of claim 1, wherein the second object is transmitted using Simple Object Access Protocol (SOAP).

7. The computer program product of claim 1, wherein the universal class is implemented at least partially automatically based on the first class and of the second class.

8. The computer program product of claim 1, wherein prior to said executing, the processor further performs:
receiving an input object from the first telephone exchange system; and
transforming the input object into the universal object.

9. A method comprising:
executing a business logic that is applicable to a first version of a telephone exchange system provided by a provider and to a second version of the telephone exchange system provided by the provider,
wherein communication with the first version of the telephone exchange system is performed using an object of a first class, the first class is compatible with the first version and is incompatible with the second version,
wherein communication with the second version of the telephone exchange system is performed using an object of a second class, the second class is compatible with the second version and is incompatible with the first version, and
wherein the business logic is implemented using a universal object of a universal class, the universal class comprises all fields and methods of the first class and of the second class;
in response to a determination to communicate with a first telephone exchange system, which implements the first version of the telephone exchange system:
transforming the universal object into a first object of the first class; and
transmitting the first object to the first telephone exchange system; and
in response to a determination to communicate with a second telephone exchange system, which implements the second version of the telephone exchange system:
transforming the universal object into a second object of the second class; and
transmitting the second object to the second telephone exchange system,
wherein the processor is part of a computerized system that comprises a plurality of version-heterogenous telephone exchange systems, including at least the first telephone exchange system and the second telephone exchange system.

10. The method of claim 9, wherein code of the universal class is implemented upon a first code segment implementing the first class and a second code segment implementing the second class.

11. The method of claim 10, wherein the first code segment or the second code segment is a high level code generated upon a Web Service Description Language (WSDL) description of an interface accessed by a corresponding communication system.

12. The method of claim 10, wherein the first code segment or the second code segment is Java code.

13. The method of claim 9, wherein said transforming comprises casting the object into the second object.

14. The method of claim 9, wherein the second object is transmitted using Simple Object Access Protocol (SOAP).

15. The method of claim 9, wherein the universal class is implemented at least partially automatically based on the first class and of the second class.

16. The method of claim 9, wherein prior to said executing, the processor further performs:
receiving an input object from the first telephone exchange system; and
transforming the input object into the universal object.

17. A communication system having a processor, the processor being configured to perform the steps of:
executing a business logic that is applicable to a first version of a telephone exchange system provided by a provider and to a second version of the telephone exchange system provided by the provider,
wherein communication with the first version of the telephone exchange system is performed using an object of a first class, the first class is compatible with the first version and is incompatible with the second version,
wherein communication with the second version of the telephone exchange system is performed using an object of a second class, the second class is compatible with the second version and is incompatible with the first version, and
wherein the business logic is implemented using a universal object of a universal class, the universal class comprises all fields and methods of the first class and of the second class;
in response to a determination to communicate with a first telephone exchange system, which implements the first version of the telephone exchange system:
transforming the universal object into a first object of the first class; and
transmitting the first object to the first telephone exchange system; and
in response to a determination to communicate with a second telephone exchange system, which implements the second version of the telephone exchange system:
transforming the universal object into a second object of the second class; and
transmitting the second object to the second telephone exchange system,
wherein the processor is part of a computerized system that comprises a plurality of version-heterogenous telephone exchange systems, including at least the first telephone exchange system and the second telephone exchange system.

18. The system of claim 17, wherein
code of the universal class is implemented upon a first code segment implementing the first class and a second code segment implementing the second class, wherein
the first code segment or the second code segment is a high level code generated upon a Web Service Description Language (WSDL) description of an interface accessed by a corresponding communication system, and wherein
the first code segment or the second code segment is Java code.

19. The system of claim 17, wherein the second object is transmitted using Simple Object Access Protocol (SOAP).

20. The system of claim 17, wherein prior to said executing, the processor further performs:
receiving an input object from the first telephone exchange system; and
transforming the input object into the universal object.
